(19) United States
(12) Patent Application Publication
(10) Pub. No.: US 2008/0011911 A1
(43) Pub. Date: Jan. 17, 2008

(54) Bracket For Illumination Device In Optical Engine

(75) Inventors: Dong-Hwan Kim, Gyeonggi-do (KR); Jin-Ho Kim, Gyeonggi-do (KR); Jong-Kyu Hong, Gyeonggi-do (KR)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: SEKONIX CO, LTD., Gyeonggi-do (KR)

(21) Appl. No.: 11/623,329

(22) Filed: Jan. 16, 2007

(30) Foreign Application Priority Data
Jul. 3, 2006 (KR) 10-2006-0061883

(51) Int. Cl. F16L 3/00

(52) U.S. Cl. 248/121

(57) ABSTRACT

Provided is a bracket for an illumination device in an optical engine. The bracket, which includes a body to be fixed to a light tunnel, and fixing pieces, connected to but spaced apart from the body, to be fixed to a barrel, comprises: arm parts which independently protrude from both side ends of the body, each arm part being bent to form a step and to be connected to either side of the fixing piece. In the bracket according to the present invention, since the arm parts have the resilience, the light tunnel is easily controlled by the resilience of the arm parts in addition to the elasticity of springs, and the reliability of the product is improved by reducing a failure ratio of the product.

### BACKGROUND OF THE INVENTION

1. Technical Field

The present invention relates to a bracket for an illumination device in an optical engine and, more particularly, to a bracket for an illumination device in an optical engine, which fixes a light tunnel to a barrel in an optical engine installed in a projection TV and provides a restoration force to the light tunnel being controlled, thereby making it easy to control the light tunnel and improving the reliability of the product.

2. Discussion of Related Art

Generally, projection televisions and liquid crystal display projectors are included in the electronic products which realize a large picture on a screen, independently from an original image, by the light scanned through a light source and enlarged and transmitted through an illumination system and a synthesis system.

A projection television using an optical engine will be described with respect to the constitution and principle as follows.

As illustrated in FIG. 1, a projection TV 10 comprises: an optical engine 20 for emitting light; a projection lens 21 for enlarging and transmitting the light emitted by the optical engine 20, a reflection mirror 30 for reflecting the light enlarged and transmitted by the projection lens 21 on the entire surface of a screen, and a transmissive screen 40 for realizing an image by the light reflected by the reflection mirror 30.

The optical engine 20 is positioned at a lower part of a case 11 of the projection TV. The reflection mirror 30 is positioned at a rear upper part of the case 11 so that the light enlarged and transmitted by the projection lens 21 is reflected toward the transmissive screen 40. The transmissive screen 40 is positioned at the front of the case 11, opposite to the reflection mirror 30, so that the light reflected by the reflection mirror 30 is realized on the entire surface of the screen 40.

As illustrated in FIGS. 2 and 3, the optical engine 20, which emits light on the screen 40 through the reflection mirror 30 of the projection TV 10, comprises: a light tunnel assay (hereinafter, named as “a light tunnel”) 25 for generating light; a barrel 22 where the light tunnel 25 is positioned; and a number of lenses (not shown), positioned in the barrel 22, for regulating the intensity of light, concentrating light to prevent spreading, and correcting the linearity of light.

One end of the light tunnel 25 is fixed to the barrel 22 and the other end thereof is movably installed in the barrel 22.

As illustrated in FIG. 3, the light tunnel 25 in the optical engine 20 is movable in up and down and side to side directions in the barrel 22.

That is, a control opening 23 is bored through an upper part of the barrel 22 and a control opening 24 is bored through one side part of the barrel 22. The control opening 23 is connected to an upper part of the light tunnel 25, by a control screw (not shown) with an end contacting with the upper part of the light tunnel 25. The control opening 24 is connected to a side part of the light tunnel 25, by a control screw (not shown) with an end contacting with the side part of the light tunnel 25.

Opposite to the control screws, springs 26 and 27 are installed inside the barrel 22, that is, at an inside lower part and the other side part of the barrel 22, thereby elastically supporting the light tunnel 25 toward the control screws.

For a more perfect image, the light tunnel 25 is movably controlled by the control screws and the springs 26 and 27.

As illustrated in FIGS. 4 and 5, one end of the light tunnel 25 is fixed to the barrel 22 by a bracket 50.

As illustrated in FIG. 5, the bracket 50 includes a body 51 and fixing grooved parts 52. The body 51 is in contact with and fixed to a surface of the light tunnel 25. The fixing grooved parts 52 are formed on the body 51 and protrude toward the light tunnel 25. Fixing units, such as bolts or screws, are inserted into the fixing grooved parts 52 to be connected to the light tunnel 25, thereby connecting the bracket 50 to the light tunnel 25.

Flat-shaped arm parts 53 are formed at upper and lower outer edges of the body 51 as shown in FIG. 5. Each arm part 53 protrudes from the body 51 at a right angle. A fixing piece 54 is formed from the arm part 53. The fixing piece 54 protrudes from the arm part 53 at a right angle. A fixing unit, such as a bolt or screw, is inserted into the fixing piece 54. A boss part 28 is formed on the barrel 22, to corresponding to the fixing piece 54. The fixing piece 54 is connected to the boss part 28 by the fixing unit.

Each fixing piece 54 is fixedly connected to each corresponding boss part 28 on the barrel 22, by using the fixing unit. When the light tunnel 25 is controlled by the control screws, the light tunnel 25 is elastically supported by a elastic force generated by the arm parts 53 with the fixing pieces 54 in addition to the springs 26 and 27. Accordingly, the light tunnel 25 receives resilience.

However, in the conventional bracket 50 having the aforementioned constitution, when the light tunnel 25 is controlled to be moved in up and down and side to side directions, the arm parts 53 are twisted, and as a result, the elastic force is generated in the direction in which the light tunnel 25 is controlled. The extent of allowing each arm part 53 to be twisted is proportional to the elastic force. In the conventional bracket, 50, the arm part 53 connecting the body 51 and the fixing piece 54 is short in length and is formed in a single plate shape, thereby supporting only a middle portion of the body 51 and the fixing piece 54. Accordingly, the extent of allowing the arm parts 53 to be twisted is low and a yield point thereof is low. Consequently, when an external force (i.e., a pressurizing force of the control screws) is continuously applied for a predetermined time, the elastic force, i.e., resilience, of the arm parts 53 is lost, so that the arm parts 53 are kept in the twisted state and the light tunnel 25 is uncontrollable

### SUMMARY OF THE INVENTION

Therefore, the present invention is directed to provide a bracket for an illumination device in an optical engine, which fixes a light tunnel to a barrel and which comprises a plurality of arm parts which are independently formed to be long in length, to be bent to increase an extent to be twisted, i.e., a yield point, and to provide the light tunnel with resilience, thereby making it easy to control the light tunnel and improving the reliability of the product by reducing a failure ratio in the product.

In accordance with an embodiment, the present invention provides a bracket for an illumination device in an optical engine, which includes a body to be fixed to a light tunnel, and fixing pieces to be connected to but spaced apart from the body and to be fixed to the barrel, comprising: arm parts independently formed at both sides of the body, each arm part protruding from a side part end of the body and being bent to form a step and to be connected to a side of the fixing piece.

### BRIEF DESCRIPTION OF THE DRAWINGS

The above and other features and advantages of the present invention will become more apparent to those of ordinary skill in the art by describing in a detail preferred embodiment(s) thereof with reference to the attached drawings in which:

FIG. 1 is a schematic view for explaining the principle of a general projection television;

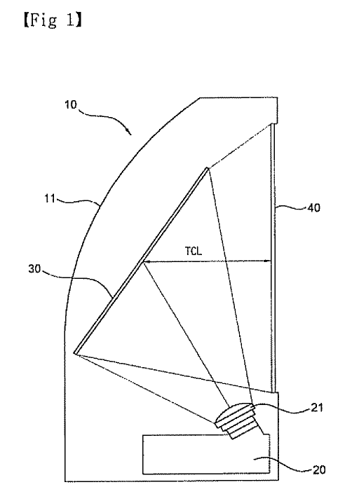

FIG. 2 is a view illustrating a conventional optical engine;

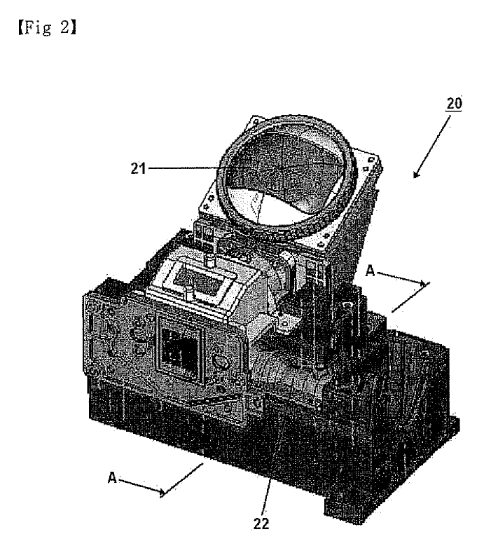

FIG. 3 is a sectional view illustrating a control unit for an illumination device in the conventional optical engine, taken along Line A-A of FIG. 2;

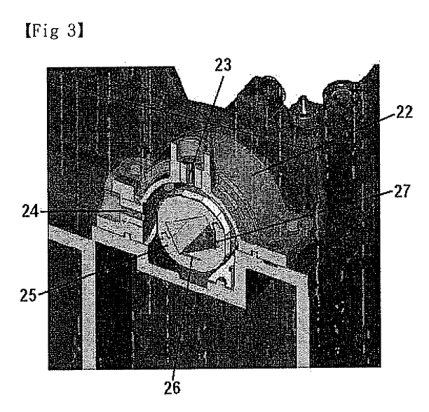

FIG. 4 is a combined view illustrating an illumination device in the conventional optical engine;

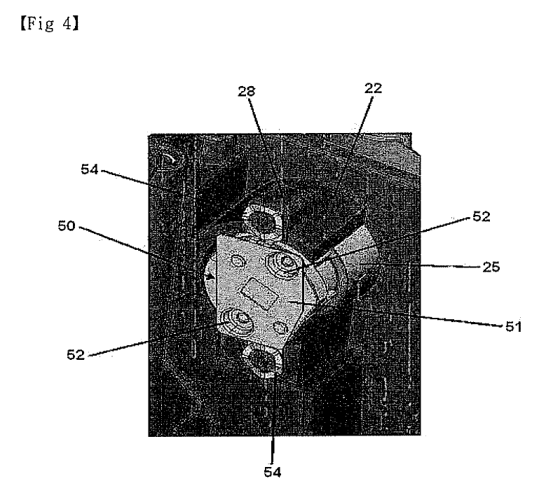

FIG. 5 is a perspective view illustrating a bracket for an illumination device in the conventional optical engine;

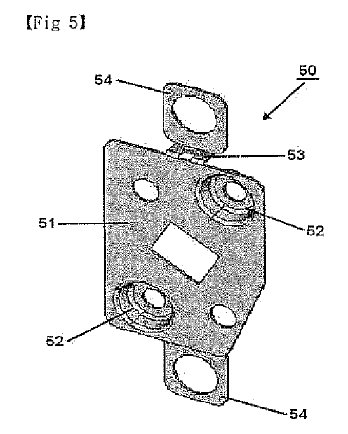

FIG. 6 is a perspective view illustrating a bracket for an illumination so device in an optical engine according to the present invention;

FIG. 7 is a combined view illustrating an illumination device in the optical engine according to the present invention; and

FIG. 8 is plan view illustrating an illumination device in the optical engine according to the present invention

### DETAILED DESCRIPTION OF THE INVENTION

The present invention will now be described more fully hereinafter with reference to the accompanying drawings, in which a preferred embodiment(s) of the invention is shown. Same reference numbers refer to the same element between the present invention and the prior art. No overlapping description between the present invention and the prior art will be presented.

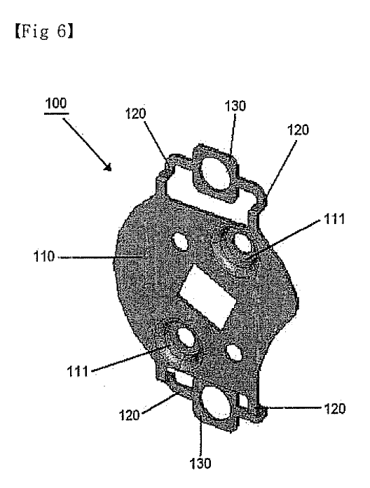

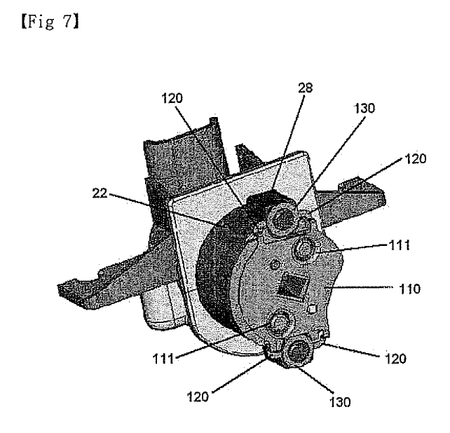

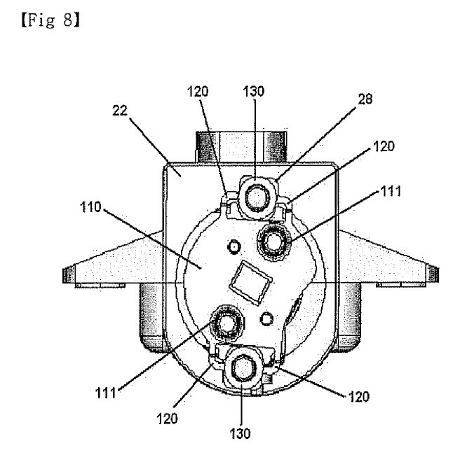

FIG. 6 is a perspective view illustrating a bracket 100 for an illumination device in an optical engine according to the present invention, FIG. 7 is a combined view illustrating an illumination device of the optical engine, and FIG. 8 is a plan view illustrating an illumination device of the optical engine.

As illustrated in FIGS. 6 through 8, the bracket 100 comprises a body 110 and fixing pieces 130. The body 110 is fixed to a side, i.e., the back of a light tunnel 25. Each fixing piece 130 is connected to but spaced apart from the body and is fixed to a barrel 22.

Specifically, the body 110, positioned in parallel to the back of the light tunnel 25, includes fixing grooved parts 111 into which fixing units, such as bolts or screws, are inserted. Each fixing grooved part 111 is formed to protrude toward the light tunnel 25. The fixing unit is inserted into the fixing piece 130 positioned in parallel to a boss part 28 of the barrel 22, so that the fixing piece 130 is fixedly connected to the boss part 28.

A plurality of arm parts 120 in a strip shape are positioned between the body 110 and the fixing piece 130 of the bracket 100.

The arm parts 120 respectively protrude from both side ends of the body 110. Each arm part 120 is bent to form a step. One end of the arm part 120 is bent to be connected to a side of the fixing piece 130. That is, the arm parts 120 respectively protrude from both side ends of the body 110 and are connected to both sides of each fixing piece 130. Since the arm parts 120 are respectively in a strip shape, a space between the two arm parts 120 positioned at both sides of the fixing piece 130 is secured at a predetermined interval, so that the arm parts 120 may be more greatly twisted.

That is, a pressurizing force of controlling the light tunnel 25 results in the both arm parts 120 being twisted in the opposite direction to each other. The twisting, i.e., the elastic force (resilience), is proportional to each arm part 120 being thinner in thickness and width but it is most greatly proportional to the spacing distance between both arm parts 120. Further, the both arm parts 120 support the body 110 and both side parts of each fixing piece 130, thereby being more resilient than the conventional arm parts 53.

When the extent of allowing the arm parts 120 to be twisted is increased, the yield point of the arm parts 120 is increased. Accordingly, even though the arm parts 120 are twisted by the pressurizing force of the control screws to continuously move the light tunnel 25 in the barrel 22 for a predetermined time, the elastic force, i.e., the resilience of the arm parts 120 is effective, thereby making it easy to control the light tunnel 25.

The operation of the bracket 100 is to controllably move the light tunnel 25 in the barrel 22, using control screws connected with the control openings 23 and 24 formed in the barrel 22.

The springs 26 and 25 are pressed by the light tunnel 25 being controlled, and the bracket 100 is deformed.

Since the body 110 of the bracket 100 is fixed to the light tunnel 24 and the fixing pieces 130 of the bracket 100 are respectively fixed to the corresponding boss parts 28 of the barrel 22, the arm parts 120 are twisted to be deformed in shape.

Then, the arm parts 120, which are deformed in shape, generate the elastic force, i.e., the resilience, to return to their original shape. The light tunnel 25 is elastically supported by the resilience of the arm parts 120, together with the elasticity of the springs 26 and 27.

Accordingly, when the control screws tightening the light tunnel 25 to be controlled are loosened, the light tunnel 25 is moved in the direction in which the control screws are unscrewed, by the arm parts 120 of the bracket 100 and the springs 26 and 27, to be re-controlled. Consequently, the light tunnel 25 is easily controlled.

As described above, in the bracket for an illumination device in an optical engine according to the present invention, the arm parts connecting the body and the fixing piece are spaced apart from each other at a predetermined distance and have a bent strip shape. Accordingly, the arm parts are capable of being more greatly twisted, that is, increased resilience. The increased resilience of the arm parts and the elasticity of the springs are applied to the light tunnel, thereby making it easy to control the light tunnel and consequently reducing a failure ratio of the product, to improve the reliability thereof.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A bracket for an illumination device in an optical engine, which includes a body to be fixed to a light tunnel, and fixing pieces, connected to but spaced apart from the body, to be fixed to a barrel, comprising:
arm parts which independently protrude from both side ends of the body, each arm part being bent to form a step and to be connected to either side of the fixing piece.
